(19) United States
(12) Patent Application Publication
(10) Pub. No.: US 2022/0210351 A1
(43) Pub. Date: Jun. 30, 2022

(54) IMAGE SENSING DEVICE AND OPERATING METHOD THEREOF

(71) Applicant: SK hynix Inc., Gyeonggi-do (KR)

(72) Inventor: Jin Su KIM, Gyeonggi-do (KR)

(21) Appl. No.: 17/350,773

(22) Filed: Jun. 17, 2021

(30) Foreign Application Priority Data
Dec. 29, 2020 (KR) 10-2020-0185889

(51) Int. Cl. H04N 5/357; G06T 5/00

(52) U.S. Cl. CPC H04N 5/357; G06T 2207/20081; G06T 5/002

(57) ABSTRACT

Disclosed is an image sensing device including an inversion pipeline suitable for generating an original image based on a source image without real noise; a noise generator suitable for generating a noise image which corresponds to a real image, by applying noise values on which real noise values are modeled for each pixel, to the original image; and a pipeline suitable for generating a dataset image, which corresponds to the source image, based on the noise image.

### CROSS-REFERENCE TO RELATED APPLICATION(S)

This application claims priority under 35 U.S.C. § 119 to Korean Patent Application No, 10-2020-0185889, filed on Dec. 29, 2020, the disclosure of which is incorporated herein by reference in its entirety.

### BACKGROUND

### 1. Field

Various embodiments of the present disclosure relate to a semiconductor design technique, and more particularly, to an image sensing device and an operating method thereof.

### 2. Description of the Related Art

Image sensing devices are devices for capturing images using the property of a semiconductor which reacts to light. Image sensing devices are generally classified into charge-coupled device (CCD) image sensing devices and complementary metal-oxide semiconductor (CMOS) image sensing devices. Recently, CMOS image sensing devices are widely used because the CMOS image sensing devices can allow both analog and digital control circuits to be directly implemented on a single integrated circuit (IC).

### SUMMARY

Various embodiments of the present disclosure are directed to an image sensing device capable of learning and denoising real noise that occurs therein, not Gaussian noise, based on a deep learning technology, and an operating method of the image sensing device.

In accordance with an embodiment of the present disclosure, an image sensing device may include: an inversion pipeline suitable for generating an original image based on a source image without real noise; a noise generator suitable for generating a noise image, which corresponds to a real image, by applying noise values, which are obtained by modeling real noise values for each pixel, to the original image; and a pipeline suitable for generating a dataset image, which corresponds to the source image, based on the noise image.

The noise generator may model the noise values based on each of image values included in the original image.

The noise values may be calculated including a square root of each of the image values.

The inversion pipeline may include: an inversion gamma module suitable for receiving the source image and generating a first image before gamma correction was applied thereto, based on an inverted gamma function; an inversion demosaic module suitable for receiving the first image and generating a second image before a demosaic operation was performed thereon, based on a set color pattern; an inversion white balance module suitable for receiving the second image and generating a third image before a white balance operation was performed thereon, based on gain values according to sensitivity; and a correction module suitable for receiving the third image and generating the original image before lens shading correction was applied thereto, based on gain values according to brightness.

The pipeline may include: a correction module suitable for receiving the noise image and generating a fourth image to which lens shading correction is applied, based on gain values according to a position of an image; a white balance module suitable for receiving the fourth image and generating a fifth image on which a white balance operation is performed, based on gain values according to sensitivity; a demosaic module suitable for receiving the fifth image and generating a sixth image on which a demosaic operation is performed; and a gamma module suitable for receiving the sixth image and generating the dataset image to which gamma correction is applied, based on a gamma function.

The image sensing device may further include a learning processor suitable for learning real noise based on the dataset image, and removing the real noise from the real image.

In accordance with an embodiment of the present invention, an image sensing device may include: a noise processor suitable for generating a dataset image by applying noise values, on which real noise values are modeled for each pixel, to a source image without real noise; and a learning processor suitable for learning real noise based on the dataset image, and removing the real noise from a real image corresponding to the source image.

The noise processor may convert the source image into an original image having a set color pattern, and then model the noise values based on each of image values included in the original image.

The noise processor may include: an inversion pipeline suitable for generating an original image based on the source image; a noise generator suitable for generating a noise image, which corresponds to the real image, by applying the noise values to the original image; and a pipeline suitable for generating the dataset image based on the noise image.

The noise generator may model the noise values based on each of image values included in the original image.

The noise values may be calculated including a square root of each of the image values.

The inversion pipeline may include: an inversion gamma module suitable for receiving the source image and generating a first image before gamma correction was applied thereto, based on an inverted gamma function; an inversion demosaic module suitable for receiving the first image and generating a second image before a demosaic operation was performed thereon, based on a predetermined color pattern; an inversion white balance module suitable for receiving the second image as and generating a third image before a white balance operation was performed thereon, based on gain values according to sensitivity; and a correction module suitable for receiving the third image and generating the original image before lens shading correction was applied thereto, based on gain values according to brightness.

The pipeline may include: a correction module suitable for receiving the noise image and generating a fourth image to which lens shading correction is applied, based on gain values according to a position of an image; a white balance module suitable for receiving the fourth image and generating a fifth image on which a white balance operation is performed, based on gain values according to sensitivity; a demosaic module suitable for receiving the fifth image and generating a sixth image on which a demosaic operation is performed; and a gamma module suitable for receiving the sixth is image and generating the dataset image to which gamma correction is applied, based on a gamma function.

In accordance with an embodiment of the present invention, an operating method of an image sensing device may include: generating an original image from an image by inversely mapping an operation of a pipeline, during a learning mode period; modeling real noise values for each pixel based on image values included in the original image, during the learning mode period; generating a dataset image by applying noise values, on which the real noise values are modeled, to the original image, through the operation of the pipeline during the learning mode period; and learning the noise values based on the original image and the dataset image.

The operating method may further include: generating a target image, which corresponds to a real image, through the operation of the pipeline during a capturing mode period; and generating an output image by denoising real noise, which is applied to the real image, from the target image according to a result of learning the noise values, during the capturing mode period.

In accordance with an embodiment of the present invention, an image sensing device may include: an inversion pipeline suitable for converting a source image into an original image including image values corresponding to multiple pixels; a noise generator suitable for generating a noise image including multiple noise values for the image values of the original image, wherein each noise value is determined based on each of the multiple pixels; a pipeline suitable for generating a dataset image based on the noise image; and a learning processor suitable for removing noises from a real image based on the dataset image.

### BRIEF DESCRIPTION OF THE DRAWINGS

FIG. 1 is a block diagram illustrating an image sensing device in accordance with an embodiment of the present disclosure.

FIG. 2 is a block diagram illustrating an image sensor illustrated in FIG. 1 in accordance with an embodiment of the present disclosure.

FIG. 3 is a diagram illustrating an example of a pixel array illustrated in FIG. 2 in accordance with an embodiment of the present disclosure.

FIG. 4 is a block diagram illustrating an image processor illustrated in FIG. 1 in accordance with an embodiment of the present disclosure,

FIG. 5 is a block diagram illustrating a noise processor illustrated in FIG. 4 in accordance with an embodiment of the present disclosure.

FIG. 6 is a block diagram illustrating an example of an inversion pipeline illustrated in FIG. 5 in accordance with an embodiment of the present disclosure.

FIGS. 7A and 7B are curve graphs corresponding to a gamma function related to a gamma module and an inverted gamma function, respectively, illustrated in FIG. 6 in accordance with an embodiment of the present disclosure.

FIG. 8 is a block diagram illustrating an example of a pipeline illustrated in FIG. 5 in accordance with an embodiment of the present disclosure.

FIG. 9 is a diagram illustrating an operation of the image sensing device illustrated in FIG. 1 in accordance with an embodiment of the present disclosure.

### DETAILED DESCRIPTION

Various embodiments of the present disclosure are described below with reference to the accompanying drawings, in order to describe in detail the present disclosure so that those with ordinary skill in art to which the present disclosure pertains may easily carry out the technical spirit of the present disclosure.

It will be understood that when an element is referred to as being “connected to” or “coupled to” another element, the element may be directly connected to or coupled to the another element, or electrically connected to or coupled to the another element with one or more elements interposed therebetween. In addition, it will also be understood that the terms “comprises,” “comprising,” “includes,” and “including” when used in this specification do not preclude the presence of one or more other elements, but may further include or have the one or more other elements, unless otherwise mentioned. In the description throughout the specification, some components are described in singular forms, but the present disclosure is not limited thereto, and it will be understood that the components may be formed in plural.

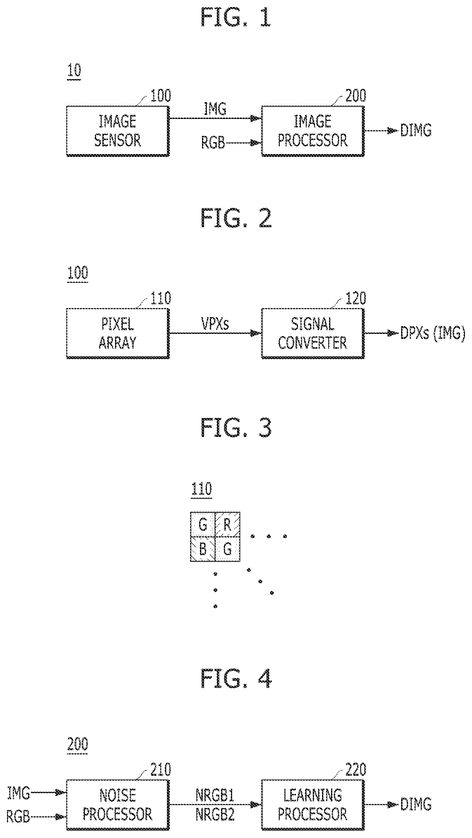

FIG. 1 is a block diagram illustrating an image sensing device 10 in accordance with an embodiment of the present disclosure.

Referring to FIG. 1, the image sensing device 10 may include an image sensor 100 and an image processor 200.

The image sensor 100 may generate a real image IMG according to incident light.

The image processor 200 may generate an output image DIMG based on the real image IMG to which real noise (hereinafter referred to as “first re& noise”) is applied and a source image RGB without real noise (hereinafter referred to as “second real noise”). For example, the image processor 200 may apply re& noise (hereinafter referred to as “third real noise”) to the source image RGB, learn the source image RGB with the third real noise, and generate the output image DIMG by denoising or removing the first read noise applied to the real it mage IMG, according to the learning result. The third re& noise may include noise values on which real noise values are modeled for each pixel.

The first to third re& noise may be distinguished from Gaussian noise. The first to third real noise may have different intensities depending on a level of a pixel signal while the Gaussian noise has the same intensity regardless of the level of the pixel signal. The real image IMG may be an image, i.e., a low-light image, captured in a place where a light source is insufficient so that the first re& noise occurs. The source image RGB may be an image previously stored in the image sensing device 10 or an image provided by an external device (not illustrated). For example, the source image RGB may be an image, i.e., a high-light image, captured in a place where a light source is sufficient so that the second real noise does not occur,

FIG. 2 is a block diagram illustrating the image sensor 100 illustrated in FIG. 1 in accordance with an embodiment of the present disclosure.

Referring to FIG. 2, the image sensor 100 may include a pixel array 110 and a signal converter 120.

The pixel array 110 may include a plurality of pixels arranged in a row direction and a column direction (refer to FIG. 3). The pixel array 110 may generate analog-type image values VPXs for each row. For example, the pixel array 110 may generate the image values VPXs from pixels arranged in a first row during a first row time, and generate the image values VPXs from pixels arranged in an n^{th} row during an n^{th} row time (where “n” is an integer greater than 2).

The signal converter 120 may convert the analog-type image values VPXs into digital-type image values DPXs. The real image IMG may include the image values DPXs. For example, the signal converter 120 may include an analog-to-digital converter.

FIG. 3 is a diagram illustrating an example of the pixel array 110 illustrated in FIG. 2 in accordance with an embodiment of the present disclosure.

Referring to FIG. 3, the pixel array 110 may be arranged in a predetermined color filter pattern. For example, the predetermined color filter pattern may be a Bayer pattern. The Bayer pattern may be composed of repeating cells each having 2×2 pixels. In each of the cells, two pixels G and G each having a green color filter (hereinafter referred to as a “green color”) may be disposed to diagonally face each other at corners thereof, and a pixel B having a blue color filter (hereinafter referred to as a “blue color”) and a pixel R having a red color filter (hereinafter referred to as a “red color”) may be disposed at the other corners thereof. The four pixels G, R, B and G are not necessarily limited to the arrangement structure illustrated in FIG. 3, but may be variously disposed according to the Bayer pattern described above.

Although the present embodiment describes as an example that the pixel array 110 has the Bayer pattern, the present disclosure is not necessarily limited thereto, and may have various patterns such as a quad pattern.

FIG. 4 is a block diagram illustrating the image processor 200 illustrated in FIG. 1 in accordance with an embodiment of the present disclosure.

Referring to FIG. 4, the image processor 200 may include a noise processor 210 and a learning processor 220.

The noise processor 210 may generate a dataset image NRGB2 by applying the noise values to the source image RGB. The dataset image NRGB2 may be images separated for each color channel. The noise processor 210 may convert the source image RGB into an original image IIMG having a predetermined color pattern, that is, the Bayer pattern, and then model the noise values based on each of image values included in the original image IIMG, The noise processor 210 may generate the dataset image NRGB2 by applying the noise values to the original image IIMG. The noise processor 210 may generate a target image NRGB1 based on the re& image IMG. The target image NRGB1 may be images separated for each color channel.

The learning processor 220 may learn the third real noise based on the dataset image NRGB2, and remove the first real noise from the target image NRGB1 corresponding to the real image IMG,

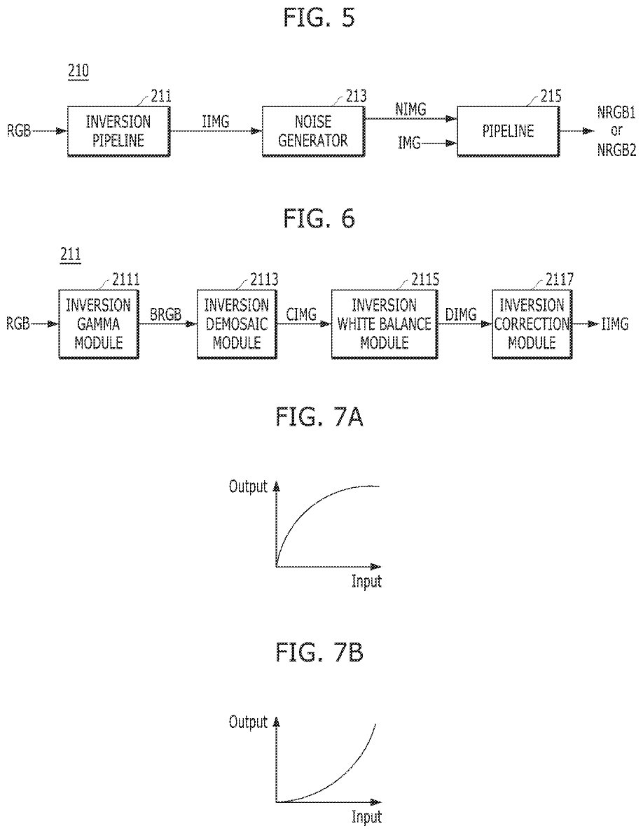

FIG. 5 is a block diagram illustrating the noise processor 210 illustrated in FIG. 4 in accordance with an embodiment of the present disclosure.

Referring to FIG. 5, the noise processor 210 may include an inversion pipeline 211, a noise generator 213 and a pipeline 215.

The inversion pipeline 211 may generate the original image HMG based on the source image RGB. The source image RGB may be images separated for each color channel, and the original image IIMG may be an image having the Bayer pattern. The inversion pipeline 211 may inversely map an operation of the pipeline 215, and generate the original image IIMG.

The noise generator 213 may generate a noise image NIMG corresponding to the real image IMG by applying the noise values to the original image IIMG, According to an example, the noise generator 213 may generate output image values included in the noise image NIMG by applying the noise values to each of input image values (i.e., pixels) included in the original image IIMG, based on “Equation 1” described below.

M=N+\sqrt{N}*RV [Equation 1]

Herein, “M” may refer to each of the output image values, “N” may refer to each of the input image values, “\sqrt{N}*RV” may refer to a noise value modeled corresponding to each of the input image values, and “RV” may refer to a random value. The random value may refer to any value which is randomly selected among values following a standard normal distribution. A probability density function f(RV) from which the random value can be selected may be calculated as shown in “Equation 2” below.

$$f ( R V ) - \frac{1}{\sqrt{2 }} {e}^{- \frac{{RV}^{2}}{2}} ( - ∞ < R V < ∞ ) \qquad [ Equation 2 ]$$

According to another example, the noise generator 213 may generate output image values included in the noise image NIMG by applying the noise values to each of input image values included in the original image IIMG, based on “Equation 3” described below.

M=N*RV2 [Equation 3]

Herein, “M” may refer to each of the output image values, “N” may refer to each of the input image values, and “RV2” may refer to a random value. The random value may refer to any value which is randomly selected among values following a standard normal distribution. A probability density function f(RV2) from which the random value can be selected may be calculated as shown in “Equation 4” below.

$$f ( R V 2 ) = \frac{1}{\sqrt{2 + N}} {e}^{- \frac{RV {2}^{2}}{2 N}} ( - ∞ < R V 2 < ∞ ) \qquad [ Equation 4 ]$$

As shown in “Equation 4” above, a root value of each of the input image values, that is, “\sqrt{N}” may be used as a standard deviation value when the random value is randomly selected among the values following the standard normal distribution.

As described in “Equation 1” to “Equation 4” above, the noise generator 213 may model the noise values based on the image values, that is, the input image values, included in the origin& image HMG. Since the noise values may be calculated including respective square roots of the input image values, the noise values may have different intensities.

The pipeline 215 may generate the dataset image NRGB2 based on the noise image NIMG, and generate the target image NRGB1 based on the real image IMG. The noise image NIMG and the real image IMG may be images each having the Bayer pattern, and the dataset image NRGB2 and the target image NRGB1 may be images separated for each color channel.

FIG. 6 is a block diagram illustrating an example of the inversion pipeline 211 illustrated in FIG. 5 in accordance with an embodiment of the present disclosure. FIG. 7A is a curve graph corresponding to a gamma function in accordance with an embodiment of the present disclosure, and FIG. 73 is a curve graph corresponding to an inverted gamma function in accordance with an embodiment of the present disclosure.

Referring to FIG. 6, the inversion pipeline 211 may include an inversion gamma module 2111, an inversion demosaic module 2113, an inversion white balance module 2115 and an inversion correction module 2117.

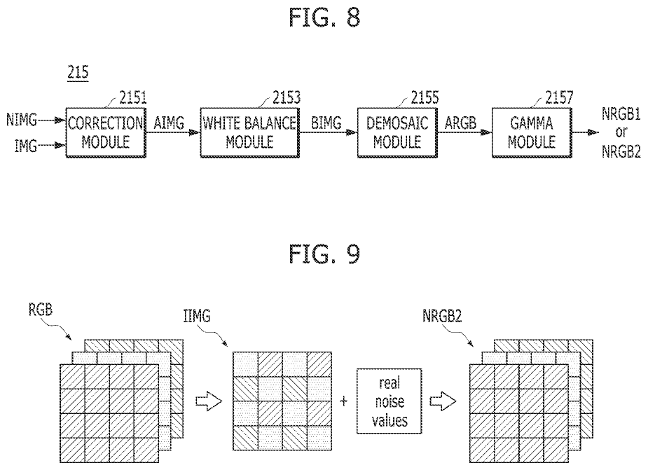

The inversion gamma module 2111 may operate by inversely mapping an operation of a gamma module 2157 in FIG. 8, which is to be described later. For example, the inversion gamma module 2111 may generate the source image RGB as a first image BRGB before gamma correction was applied thereto, based on an inverted gamma function. The inverted gamma function may correspond to an inverse curve of a gamma function (refer to FIG. 73). The gamma function may represent an output brightness value “Output” with respect to an input brightness value “Input”, and correspond to a log curve (refer to FIG. 7A). The inversion gamma module 2111 may generate the first image BRGB by multiplying inverted log values by image values included in the source image RGB, respectively.

The inversion demosaic module 2113 may operate by inversely mapping an operation of a demosaic module 2155 in FIG. 8, which is to be described later. For example, the inversion demosaic module 2113 may generate the first image BRGB as a second image CIMG before a demosaic operation was performed thereon, based on the predetermined color pattern. The inversion demosaic module 2113 may generate the second image CIMG having the Bayer pattern, based on the first image BRGB separated for each color channel.

The inversion white balance module 2115 may operate by inversely mapping an operation of a white balance module 2153 in FIG. 8, which is to be described later. For example, the inversion white balance module 2115 may generate the second image CIMG as a third image DIMG before a white balance operation was performed thereon, based on gain values according to sensitivity. The inversion white balance module 2115 may generate the third image DIMG by dividing image values included in the second image CIMG by the gain values, respectively. In this case, the inversion white balance module 2115 may variously generate the third image DIMG by randomly generating and applying the gain values.

The inversion correction module 2117 may operate by inversely mapping an operation of a correction module 2151 in FIG. 8, which is to be described later. For example, the inversion correction module 2117 may generate the third image CIMG as the original image IIMG before lens shading correction was applied thereto, based on inverted gain values according to a position of the image. The inverted gain values may include values opposite to gain values used by the correction module 2151. The inversion correction module 2117 may generate the original image IIMG by applying the inverted gain values to the image values included in the third image CIMG, respectively.

FIG. 8 is a block diagram illustrating an example of the pipeline 215 illustrated in FIG. 5 in accordance with an embodiment of the present disclosure.

Referring to FIG. 8, the pipeline 215 may include the correction module 2151, the white balance module 2153, the demosaic module 2155 and the gamma module 2157.

The correction module 2151 may generate the noise image NIMG or the real image IMG as a fourth image AIMG to which the lens shading correction is applied, based on gain values according to the position of the image. The lens shading correction is a technique for correcting a phenomenon in which brightness is lowered by a lens toward the outside of the image. The correction module 2151 may generate the fourth image AIMG by applying the gain values to the image values included in the noise image NIMG, respectively, or generate the fourth image AIMG by applying the gain values to the image values included in the real image IMG, respectively.

The white balance module 2153 may generate the fourth image AIMG as a fifth image BIMG on which the white balance operation is performed, based on the gain values according to the sensitivity. The white balance operation is a technology of correcting sensitivity that varies depending on color. The white balance module 2153 may generate the fifth image BIMG by multiplying image values included in the fourth image AIMG by the gain values, respectively.

The demosaic module 2155 may generate the fifth image BIMG as a sixth image ARGB on which the demosaic operation is performed. The demosaic module 2155 may generate the sixth image ARGB separated for each color channel, based on the fifth image BIMG having the Bayer pattern.

The gamma module 2157 may generate the sixth image ARGB as the dataset image NRGB2 or the target image NRGB1 based on the gamma function. The gamma module 2157 may generate the dataset image NRGB2 or the target image NRGB1 by multiplying the log values according to the brightness values by image values included in the sixth image ARGB, respectively.

Hereinafter, an operation of the image sensing device 10 in accordance with an embodiment of the present disclosure, which has the above-described configuration, is described.

FIG. 9 is a diagram illustrating the operation of the image sensing device 10 illustrated in FIG. 1 in accordance with an embodiment of the present disclosure.

Referring to FIG. 9, the image processor 200 may apply the third real noise during a learning mode period to at least one source image RGB, and learn the one source image RGB with the third real noise. The source image RGB may be a clean image from which the second real noise is denoised or removed, and the third real noise may include the noise values on which the real noise values are modeled for each pixel.

More specifically, the noise processor 210 may convert the source image RGB into the original image IIMG having the Bayer pattern, during the learning mode period, and then model the noise values based on each of the image values included in the original image IIMG, In this case, the noise processor 210 may generate the original image IIMG having the Bayer pattern by inversely mapping the operation of the pipeline 215. The noise processor 210 may generate the dataset image NRGB2 by applying the noise values to the original image IIMG. In this case, the noise processor 210 may generate the dataset image NRGB2 separated for each color channel through the operation of the pipeline 215. The learning processor 220 may learn the third real noise in a supervised learning manner based on the source image RGB and the dataset image NRGB2.

The image sensor 100 may generate the real image IMG having the Bayer pattern, according to incident light during a capturing mode period. The image processor 200 may generate the output image DIMG based on the real image IMG during the capturing mode period. For example, the image processor 200 may generate the target image NRGB1 separated for each color channel through the operation of the pipeline 215, and generate the output image DIMG by denoising or removing the first real noise, which is applied to the real image IMG, from the target image NRGB1, according to the learning result.

The output image DIMG may be generated as an image having a level that does not meet expectations (hereinafter referred to as an “output image below expectations”), according to the performance of the image sensor 100 and/or image processor 200. In this case, the image processor 200 may perform an additional learning operation that is, a fine-tuning operation, and use the output image DIMG below expectations when performing the additional learning operation. For example, the image processor 200 may generate a plurality of target images NRGB1, corresponding to the output image DIMG below expectations, in the same manner, and generate a plurality of output images DIMG based on the plurality of target images NRGB1. The image processor 200 may perform the additional learning operation by using an average image of the plurality of output images DIMG as the source image RGB and using each of the plurality of target images NRGB1 as the dataset image NRGB2. Performance degradation of the output images DIMG according to the performance of the image sensor 100 and/or image processor 200 may be improved through the additional learning operation.

In accordance with the embodiment of the present disclosure, real noise may be learned and denoised based on a deep learning technique.

In accordance with the embodiment of the present disclosure, real noise, not Gaussian noise, may be learned and denoised based on a deep learning technique, thereby obtaining a clean image from which the real noise is removed.

In accordance with the embodiment of the present disclosure, since a dataset image to which real noise is applied is generated to correspond to a source image, the present disclosure is easily compatible with a deep learning network developed in the prior art.

While the present disclosure has been illustrated and described with respect to specific embodiments, the disclosed embodiments are provided for the description, and not intended to be restrictive. Further, it is noted that the present disclosure may be achieved in various ways through substitution, change, and modification that fall within the scope of the following claims, as those skilled in the art will recognize in light of the present disclosure.

What is claimed is:

1. An image sensing device comprising:
an inversion pipeline suitable for generating an original image based on a source image without real noise;
a noise generator suitable for generating a noise image, which corresponds to a real image, by applying noise values, on which real noise values are modeled for each pixel, to the original image; and
a pipeline suitable for generating a dataset image, which corresponds to the source image, based on the noise image.

2. The image sensing device of claim 1, wherein the noise generator models the noise values based on each of image values included in the original image.

3. The image sensing device of claim 2, wherein the noise values are calculated including a square root of each of the image values.

4. The image sensing device of claim 2, wherein the noise values are defined based on a root value and a random value of each of the image values, the random value being any value randomly selected among values following a standard normal distribution.

5. The image sensing device of claim 1, wherein the inversion pipeline includes:
an inversion gamma module suitable for receiving the source image and generating a first image before gamma correction was applied thereto, based on an inverted gamma function;
an inversion demosaic module suitable for receiving the first image and generating a second image before a demosaic operation was performed thereon, based on a set color pattern;
an inversion white balance module suitable for receiving the second image and generating a third image before a white balance operation was performed thereon, based on gain values according to sensitivity; and
a correction module suitable for receiving the third image and generating the original image before lens shading correction was applied thereto, based on gain values according to brightness.

6. The image sensing device of claim 1, wherein the pipeline includes:
a correction module suitable for receiving the noise image and generating a fourth image to which lens shading correction is applied, based on gain values according to a position of an image;
a white balance module suitable for receiving the fourth image and generating a fifth image on which a white balance operation is performed, based on gain values according to sensitivity;
a demosaic module suitable for receiving the fifth image and generating a sixth image on which a demosaic operation is performed; and
a gamma module suitable for receiving the sixth image and generating the dataset image to which gamma correction is applied, based on a gamma function.

7. The image sensing device of claim 1, further comprising a learning processor suitable for learning real noise based on the dataset image, and removing the real noise from the real image.

8. An image sensing device comprising:
a noise processor suitable for generating a dataset image by applying noise values, on which real noise values are modeled for each pixel, to a source image without real noise; and
a learning processor suitable for learning real noise based on the dataset image, and removing real noise from a real image corresponding to the source image.

9. The image sensing device of claim 8, wherein the noise processor converts the source image into an original image having a set color pattern, and then models the noise values based on each of image values included in the original image.

10. The image sensing device of claim 8, wherein the noise processor includes:
an inversion pipeline suitable for generating an original image based on the source image;
a noise generator suitable for generating a noise image, which corresponds to the real image, by applying the noise values to the original image; and
a pipeline suitable for generating the dataset image based on the noise image.

11. The image sensing device of claim 10, wherein the noise generator models the noise values based on each of image values included in the original image.

12. The image sensing device of claim 11, wherein the noise values are calculated including a square root of each of the image values.

13. The image sensing device of claim 11, wherein the noise values are defined based on a root value and a random value of each of the image values, the random value being any value randomly selected among values following a standard normal distribution.

14. The image sensing device of claim 10, wherein the inversion pipeline includes:
an inversion gamma module suitable for receiving the source image and generating a first image before gamma correction was applied thereto, based on an inverted gamma function;
an inversion demosaic module suitable for receiving the first image and generating a second image before a demosaic operation was performed thereon, based on a predetermined color pattern;
an inversion white balance module suitable for receiving the second image as and generating a third image before a white balance operation was performed thereon, based on gain values according to sensitivity; and
a correction module suitable for receiving the third image and generating the original image before lens shading correction was applied thereto, based on gain values according to brightness.

15. The image sensing device of claim 10, wherein the pipeline includes:
a correction module suitable for receiving the noise image and generating a fourth image to which lens shading correction is applied, based on gain values according to a position of an image;
a white balance module suitable for receiving the fourth image and generating a fifth image on which a white balance operation is performed, based on gain values according to sensitivity;
a demosaic module suitable for receiving the fifth image and generating a sixth image on which a demosaic operation is performed; and
a gamma module suitable for receiving the sixth image and generating the dataset image to which gamma correction is applied, based on a gamma function.

16. An operating method of an image sensing device, comprising:
generating an original image from an image by inversely mapping an operation of a pipeline, during a learning mode period;
modeling real noise values for each pixel based on image values included in the original image, during the learning mode period;
generating a dataset image by applying noise values, on which the real noise values are modeled, to the original image, through the operation of the pipeline during the learning mode period; and
learning the noise values based on the original image and the dataset image.

17. The operating method of claim 16, further comprising:
generating a target image, which corresponds to a real image, through the operation of the pipeline during a capturing mode period; and
generating an output image by denoising real noise, which is applied to the real image, from the target image according to a result of learning the noise values, during the capturing mode period.
